(19) United States
(12) Patent Application Publication
(10) Pub. No.: US 2005/0188793 A1
(43) Pub. Date: Sep. 1, 2005

(54) Gripping dies and method

(76) Inventor: Doyle E. Cherry, League City, TX (US)

Correspondence Address: THE MATTHEWS FIRM, 2000 BERING DRIVE, SUITE 700, HOUSTON, TX, 77057, US

(21) Appl. No.: 10/789,213

(22) Filed: Feb. 27, 2004

(51) Int. Cl. B25B 13/50

(52) U.S. Cl. 81/57.33

(57) ABSTRACT

An improved die or die insert for gripping tubulars such as in, but not limited to, oilfield tongs. The die surface, which contacts the tubular, may comprise a particle gripping coating wherein the gripping operation leaves no more than visually imperceptible marks on the tubular. Further, the dies may vary in configuration and comprise a granular particle coated convex shaped die, a granular particle coated concave die, wherein said gripping surface does not match the diametrical size of the tubular being gripped, and a toothless or ridge free concave shaped die, which substantially matches the curvature of the tubular being gripped. Wherein the toothless or ridge free concave shaped die may be of a material softer than the tubular material or may be of a hardness substantially the same of greater than the tubular being gripped.

### TECHNICAL FIELD

This invention relates to apparatuses for engaging and gripping tubulars. More specifically, it relates to gripping dies which substantially eliminate damage to tubulars caused by die gouging and scratching.

### BRIEF BACKGROUND

Various types of dies have been provided to grip tubular members such as, but not limited to, oilfield pipe. Mechanical grip tongs typically comprised dies that were driven against a tubular member, to be gripped, through the use of a drag ring. The drag ring rotation needed to be retarded in some manner to allow the dies to contact the tubular members. The amount of retardation of the drag ring rotation typically created the force of the initial bite of the die against the tubular member. These dies were typically either convex shaped and thus created only a small contact area against the tubular to be gripped or were concave having a curvature substantially matching the diameter of the tubular being gripped. Most of these dies had some type of “teeth” or ridges which covered the die surfaces being in contact with the tubulars. Typically, the “teeth” or ridges would embed in the tubular being gripped and thus left marks, scratches or gouges in the tubular members being gripped. This surface damage would typically limit the useful life of the tubulars. This damage became even more critical when the material of the tubulars is any type of a corrosion resistant alloy steel. In this case, the damage to the tubular precipitates corrosion attack on the steel including corrosion in the form of sulfide stress cracking. To alleviate these problems, the industry began searching for dies which would at least minimize the marking, scratching, and gouging of the tubulars being gripped.

One such solution was the use of power tongs and dies with smoother tubular contact surfaces. The power tongs typically utilize a hydraulic or pneumatic ram to force concave shaped dies, which generally conformed to the diameter of the tubular, against the tubular to be gripped. However, the disadvantages included over pressuring the dies causing tubular deformation and slippage, along the tubular, causing marking or scratching of the tubular.

U.S. Pat. No. 6,378,399 (issued to Bangert, Apr. 30, 2002) disclosed a granular particle gripping surface which could be applied on the surface of a concave shaped die. The granular particle gripping surface actually produced the equivalent of many very small “teeth” which would grip the tubular. These very small “teeth” left almost no mark or scratch on the tubular. However, this granular particle surface was taught as only applying to a concave shaped die which substantially matched the diameter of the tubular because it was believed that without contact over a substantial amount of tubular surface area there would not be enough gripping surface to grip the tubular and produce the required torque for make-up or break-out of the tubular connections. This patent further specifically taught only use in a power grip tong because, again, it was not believed or not known that such a surface could be applied to the convex shaped die, because the convex shaped die had only a small contact area with the tubular which it was gripping as compared to the concave shaped die. Therefore, it was believed there would not be sufficient gripping surface. A further disadvantage was that because the die was shaped substantially to match the diameter of the tubular, the die would have to be changed out every time the tubular diameter was changed. Again, the teachings of the patent were that unless the concave curvature of the die matched the outside diameter of the tubular, there would not be enough gripping surface to allow the generation of torque required to make-up or break-out the tubular connections.

U.S. Pat. No. 5,172,513 (issued to Wesch, Jr., Dec. 22, 1992) disclosed tongs which did not utilize the power tong ram. This patent disclosed jaws and/or dies that were both concave shaped and substantially matched the diameter of the tubular member to be gripped. However, these jaws were flipped out using a drag ring, like mechanical grip tongs, and thus provided gripping of the tubular without the power ram. This patent taught using the mechanical grip tong drag ring technology to pre-load the dies against the tubular before applying the torque. The surface of the dies was not as rough as the original “tooth” or ridge design, however the dies did have smaller ridges on the tubular contacting surface. Thus, the patent disclosed that gripping could be achieved with fewer marks, however it was still not able to achieve a no-mark gripping wherein the tubular had no damage or possibly microscopic damage but not visual damage. Thus, a primary disadvantage of the teachings of this patent was that it could not achieve the gripping with no mark on the tubular. It was believed that without some type of ridges, it would not be possible to again grip in order to create sufficient torque to make-up or break-out the tubulars. Thus, in conclusion, the current technologies, including patents, do not teach or disclose the use of the mechanical grip type of tongs in gripping tubulars without leaving marks, scratches or gouges. Consequently, those skilled in the art will appreciate that the present invention discloses dies which can be used with mechanical grip type tongs in gripping tubulars without leaving marks, scratches or gouges and thus meet many of the industry requirements regarding such.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers.

FIG. 1 illustrates a perspective view of a convex die and further illustrating a section of the granular particle coating.

FIG. 1A illustrates a front view of a mechanical grip tong with convex dies engaging a tubular.

FIG. 1B illustrates a perspective view of a convex die and further illustrating that the die can be used for several different diameter tubulars.

FIG. 1C illustrates a partial front view of a mechanical grip tong further illustrating a convex dies and adaptor.

FIG. 2 illustrates a front view of a mechanical grip tong with a toothless or ridge free surface concave dies with a curvature substantially matching the engaged tubular diameter.

FIG. 2B illustrates a more detailed view of a mechanical tong with a toothless or ridge free surface concave die insert with a curvature substantially matching the engaged tubular diameter.

FIG. 2C illustrates a perspective view of a concave die with a curvature larger than the engaged tubular diameter and further illustrates that the die can be used for several different diameter tubulars.

FIG. 2D illustrates a side view of a v-shaped die.

FIG. 3 illustrates a perspective view of a concave die coated with a granular particle coating and with a curvature larger than the engaged tubular diameter and further illustrates that the die can be used for several different diameter tubulars.

FIG. 4 illustrates a perspective view of a mechanical grip tong utilizing a conventional actuated hydraulic cylinder for drag ring braking.

FIG. 4A illustrates a side view of a mechanical grip tong utilizing a conventional actuated hydraulic cylinder and brake apparatus for drag ring braking.

FIG. 4B illustrates a front view of a mechanical grip tong utilizing a brake apparatus for drag ring braking.

FIG. 5 illustrates a front pictorial view of a toothless or ridge free surface concave die.

FIG. 6 illustrates a front pictorial view of a mechanical grip tong with convex dies disengaged from a tubular.

FIG. 7 illustrates a front pictorial view of a mechanical grip tong with the convex dies beginning to engaged a tubular.

FIG. 8 illustrates a front pictorial view of a mechanical grip tong with the convex dies further engaging a tubular.

FIG. 9 illustrates a front pictorial view of a mechanical grip tong with the convex dies engagement of a tubular substantially complete.

### DETAILED DESCRIPTION OF EMBODIMENTS OF THE INVENTION

The oil and gas industry, in which the present invention may, but is not limited to, be embodied utilizes various standard nomenclature for certain devices and apparatuses which frequently utilized particularly in the exploration and production side of the industry. For instance, the dies used for non-mark tubular make-up/break-out applications are commonly referred to in the industry as “friction grip dies” and all dies that penetrate the tubulars whether with standard machined teeth or micro teeth composed of fine tungsten carbide chips are referred to as “mechanical grip dies” and all tongs withjaws driven by hydraulic power are called “power grip tongs” and all tongs that use a drag ring to power thejaws are called “mechanical grip tongs. The tubular make-up/break-out applications in the industry are commonly called “pipe bucking” orjust “bucking” and the make-up/break-out applications are commonly called “buck-on or buck-off” respectively. The term “marking” a pipe refers to any penetration of or scratching the outside of the tubular. Silicone drywall mesh may be used with any dies to increase friction and/or provide a non-penetration barrier between the tubular surface and any die surface to avoid “marking”. The disclosure herein below, in an effort of clarity, describes the dies by their gripping surface curvature, such as concave or convex, and tongs as being “power grip” or “mechanical grip”. However, it should be appreciated that these, more simplistic, terms are intended to cover dies and tongs as described herein above without the specific inclusion of the typical oil and gas industry nomenclature and as such, the descriptive nomenclature used herein is not intended as a limitation of the present invention.

Prior art discloses a granular particle gripping surface on a concave shaped die. However, as briefly described herein above, the prior art discloses only such a coating on a concave shaped die and does not disclose nor suggest the possibility of using such a coating on a convex shaped die. There is no teaching nor suggestion of a granular particle coated convex die due to the belief that a convex die, even coated, would not have a sufficient surface area contact, with the gripped tubular, to produce enough friction to generate the torque required for the make-up or break-out of tubular members. Further, the prior art teaches specifically the use of a die which matches the diameter of the tubular which it grips and its use in a power grip tong. In sharp contrast, the present invention discloses the use of a granular particle coating in conjunction with a convex shaped die, used in a mechanical grip tong, to achieve superior gripping performance without damaging or marking, beyond a substantially microscopic level, the tubulars being gripped.

Another patent discloses mechanical grip jaws and/or dies which flip out and grip a tubular due to a drag ring and a pre-load, applied to the drag ring prior to turning the tubular. However, this art also discloses the need for concave shaped dies which match the diameter of the tubular being gripped. Further, the prior art still does not disclose the use of a convex shaped die. Still further, the prior art specifically discloses the need for some type of serrated surface, being ridges or small “teeth”, in order to properly grip the tubular. It should be noted that the prior art casually mentions, in two concluding paragraphs intended for global coverage, that the dies can have a smooth contact surface. However, there is no other mention, description of use, any description of operation, other any other form of enablement of a die having a smooth contact surface, in the disclosure or in the accompanying figures.

Although the prior art suggests gripping a tubular with little marking or no marking, it does not disclose a convex shaped die due to an industry wide belief that there is insufficient surface area contact between a convex die and the tubular it is gripping to be able to produce torque required for the make-up and break-out of tubular members while maintaining a no-mark surface. Prior art patents disclose and suggest that a large surface area contact with the tubular is required in order to achieve the torque necessary to make-up or break-out tubular joints.

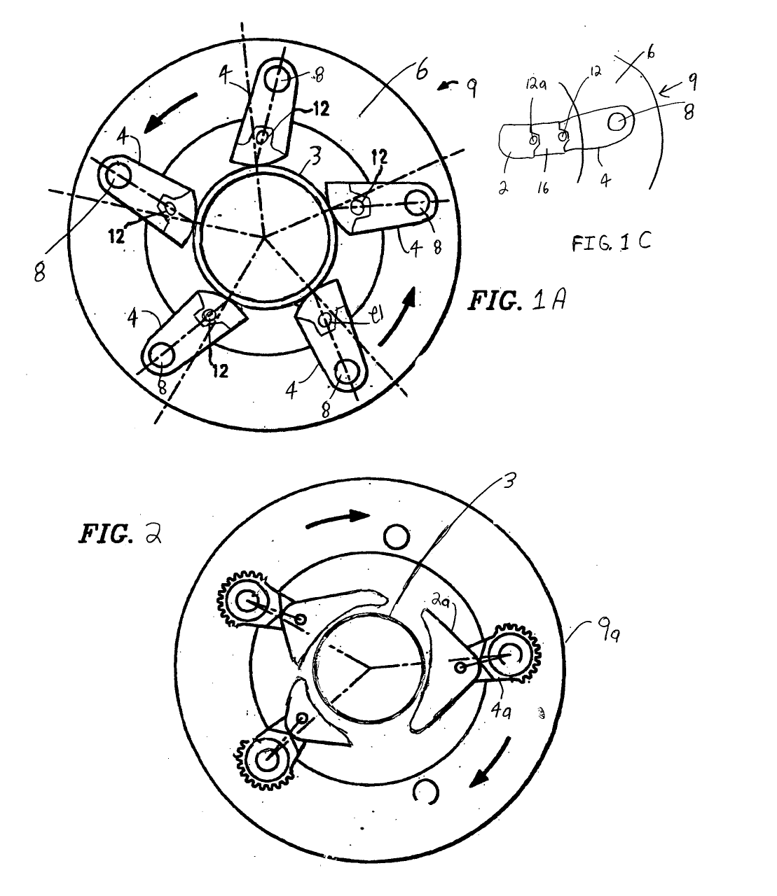

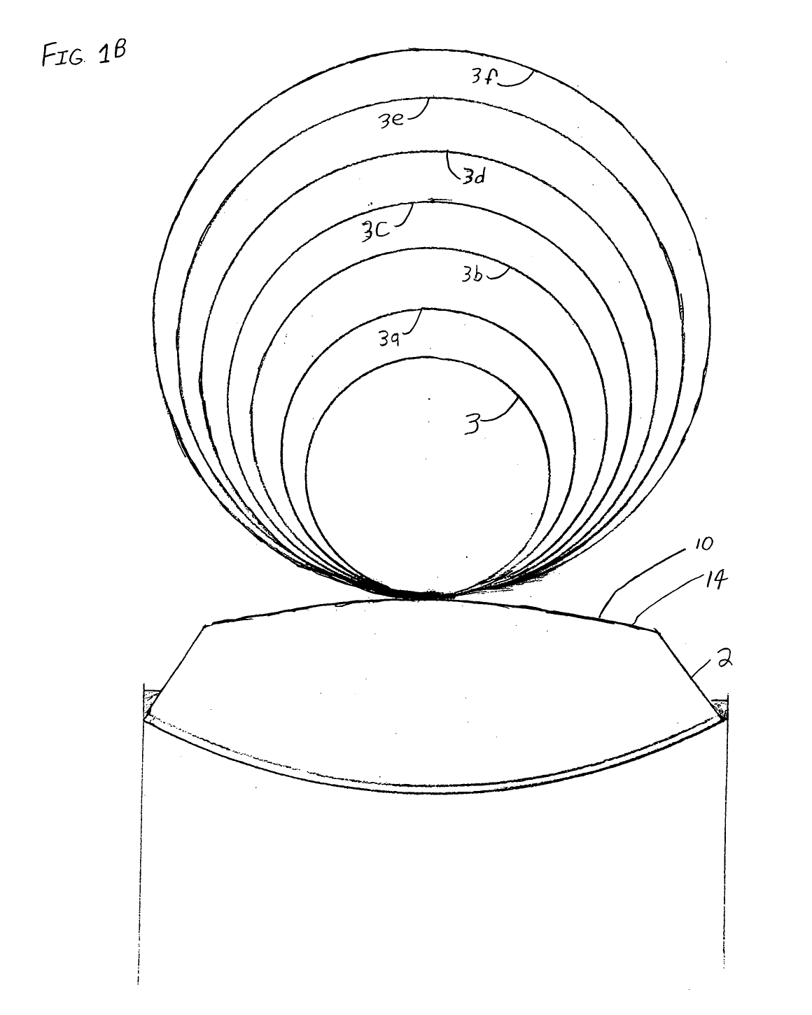

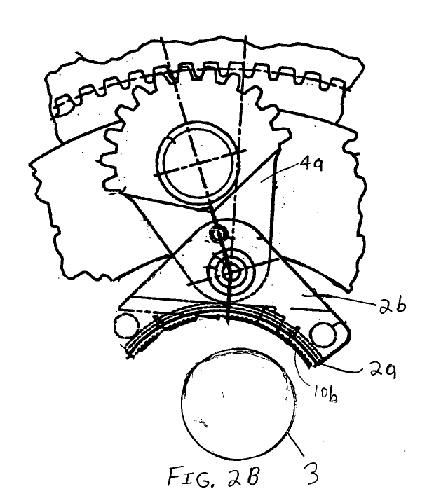

FIG. 1 illustrates an embodiment of the present invention. The die 2 illustrated in FIG. 1 has a substantially convex surface 10. Surface 10 is also the surface which contacts the tubular 3 (FIG. 1a) being gripped. Die 2 is preferably connected to a jaw 4 at connection point 12. It should be appreciated that the connection between the jaw 4 and the die 2 is a conventional connection and may be a pin, bolt, rivet, and the like. It should further be appreciated that this connection should be sufficient to properly maintain the jaw 4 to die 2 connection but still allow a straightforward and field suitable method for speedy detachment so as to be able to change the die 2 as required without undo downtime. The jaw or jaws 4 are, in turn, pivotally connected to a drag ring 6 through a pin 8. The pin 8 can be any type of fastener suitable for pivotal attachment and may be of a metal or non-metal material. As the tong 9 begins to rotate, the drag ring 6 causes the jaws 4 to flip out die 2 into contact with the tubular. Detail description of a mechanical tong drag ring operation is found in the prior art.

It should be appreciated that the drag ring 6 preferably creates a pre-load pressure of the dies 2 against the tubular member 3. This pre-load pressure is preferably a function of the resistance to rotation of the drag ring 6 and thus the amount or degree of flipping of the die 2 against the tubular member. This resistance to rotation, of the drag ring, is typically a function of any braking action applied against the drag ring 6. Prior art drag rings utilized a replaceable lug inserted along the outer edge of the drag ring. This lug was typically of a non-metallic material and would require periodic replacement as it was designed to wear out rather than score or damage the surface with which it made frictional contact. Another prior art braking system utilized a complex hydraulic system.

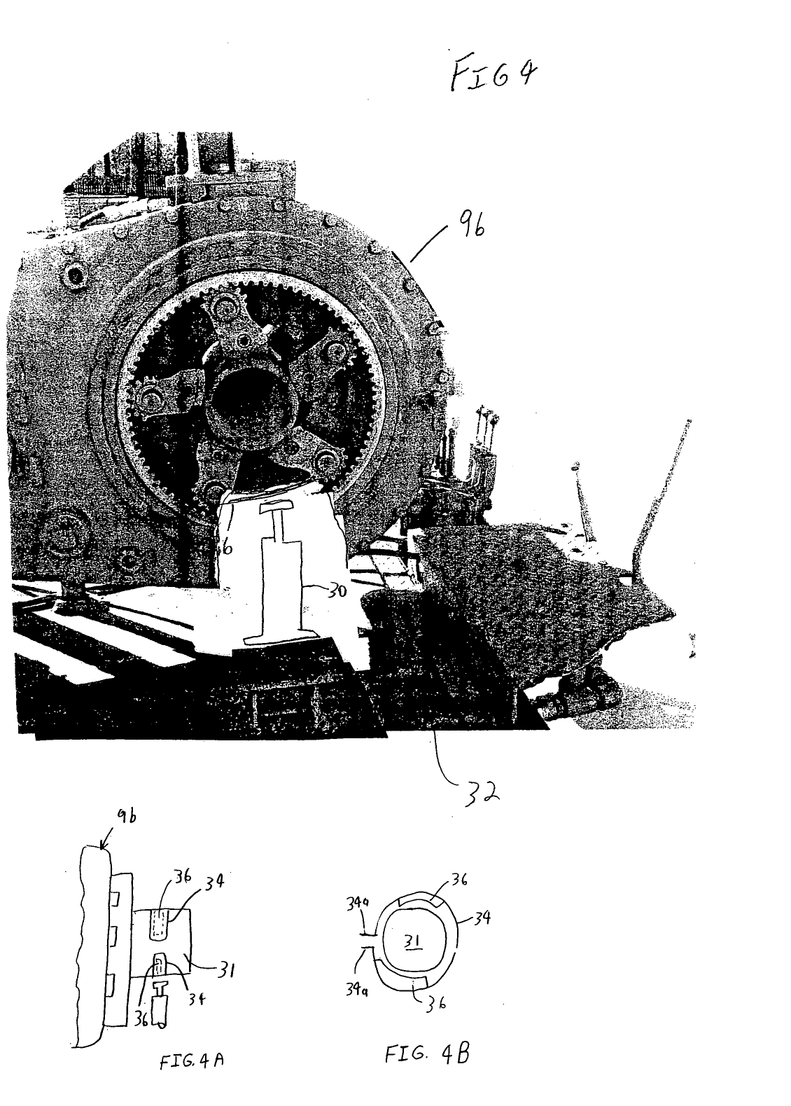

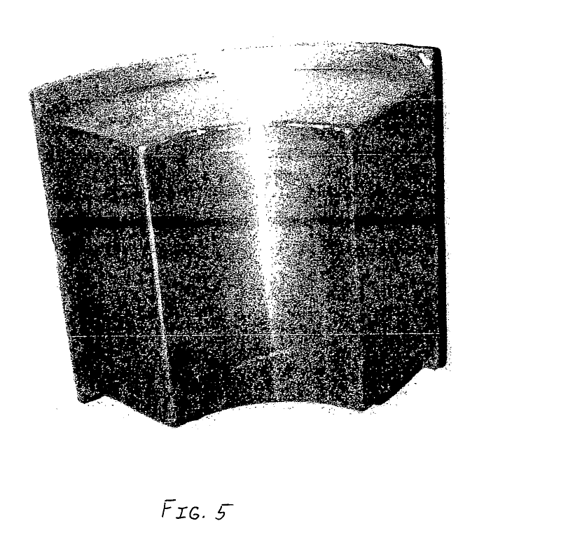

In another embodiment, the drag ring 6 braking action can preferably be accomplished through the use of a conventional actuated hydraulic cylinder. FIGS. 4 and 4A illustrate the use of a conventional actuated hydraulic cylinder 30 in applying the braking action to the drag ring 6. Preferably, this conventional actuated hydraulic cylinder 30 may be a conventional jack, such as but not be limited to, a hydraulic jack, a pneumatic jack, electric jack, manual jack, or any combination thereof, a double actuated hydraulic cylinder, a single actuated hydraulic cylinder combined with a spring actuated retraction device, or other similar extending or retracting device. The a conventional actuated hydraulic cylinder 30 is preferably placed between the tong 9b and a stable surface, such as the tong floor support 32. When the conventional actuated hydraulic cylinder 30 is extended, it will preferably contact directly to the drag ring 6 or to a plate or ring which rotates in tandem with the rotating drag ring 6. It should be appreciated that the contact end of the conventional actuated hydraulic cylinder 30 can comprise a conventional brake shoe, a metallic insert such as, but not limited to, aluminum, a copper alloy, a mild steel, or preferably other element which is softer than the drag ring 6 or connected plate. It should be understood that direct access to the drag ring 6 may not be possible without the modification of certain existing tongs. In such a circumstance, an access to the drag ring 6 needs to be fabricated in the existing tong cover. Such an access can be fabricated by conventional means and is thus not described in detail herein. It should be further appreciated that such opening needs to be sufficiently sized to allow the conventional actuated hydraulic cylinder's braking surface to pass through the opening for the desired contact. Further, the conventional actuated hydraulic cylinder 30 can be manually actuated, such as, but not limited to, a hand pump or hand crank, or it can be automatically actuated, such as, but not limited to, by suitably selected and conventional fluid or electric power system. It should be understood that the use of the conventional actuated hydraulic cylinder 30 preferably attains the best braking control for producing the necessary pre-load of the dies against the tubular members being gripped.

In another embodiment, illustrated in FIG. 4A, a brake drum 31 is attached directly to the drag ring 6. It should be appreciated that the brake drum 31 can be a metallic cylinder or can be of a variety of materials so long as the cylinder poses sufficient rigidity and friction to function as a braking apparatus. A brake ring 34, preferably encompasses the brake drum 31. The brake ring 34 will preferably have disposed about it at least one conventional brake pad 36 which when actuated will retard the motion of the brake drum 31. It should be appreciated that preferably there will be more than one brake pad 36 and such brake pads 36 will be substantially equally spaced around the circumference of the brake drum 31. The conventional actuated hydraulic cylinder 30 can be extended so as to apply pressure to the brake ring 34. The brake ring 34 and its brake pad 36 will in turn preferably apply a frictional force against the brake drum 31 and thus retard the rotation of the drag ring 6. It should be appreciated that a variety of embodiments can be made utilizing the brake ring 34 and brake pads 36. Such embodiments may include, but not be limited to, two brake rings 34, wherein each brake ring 34 covers substantially one-hundred and eighty (180) degrees of the circumference of the brake drum 31. In this embodiment, two brake pads 36 could also extend substantially the same distance as the brake rings 34 or several brake pads 36 could be substantially equally spaced about the circumference of the brake drum 31. Another embodiment, such as illustrated in FIG. 4B, may have the brake rings 34 further comprise a flange 34a disposed about at least one end of the brake ring 34. In this embodiment, the flanges 34a could be crimped or pressed together to apply the braking force to the brake drum 31. It should also be noted that the conventional actuated hydraulic cylinder 30 may also be utilized to apply a force against one such flange 34a to in turn apply a braking force against the brake drum 31 and thus the drag ring 6. Still further, if the brake ring 34 is of a one piece design with one end attached near the brake drum 31 and the second end having a flange 34a disposed about it, the application of force, by the conventional actuated hydraulic cylinder 30, against the flange 34a would preferably cause a substantially even brake force against the brake drum 31.

As the rotation of the brake drum 31 is slowed, the result will be substantially similar to the effect of the drag ring 6 as the dies will be forced to swing out against the tubular and thus provide a sufficient gripping force. It should be appreciated that the use of the brake drum 31 and the spacing of the brake pads 36 can provide a more concentric grip of the dies against the tubular. In particular, this embodiment is preferred over the single conventional actuated hydraulic cylinder 30 with direct contact to the drag ring 6, at only one point, when the required torque is higher such as, but not limited to, larger diameter tubulars. It should also be appreciated that the brake pads 36 can be conventional brake shoe, a metallic insert such as, but not limited to, aluminum, a copper alloy, a mild steel, or preferably other element which is softer than the brake drum 31.

It should be understood that the use of a conventional actuated hydraulic cylinder 30 is not intended to limit the means by which the drag ring 6 braking is actuated. Other means such as, but not limited to, clamps, vices, screws, bolts, weights, and other devices can be used to apply pressure to the drag ring 6 and/or brake drum 31.

Referring again to FIG. 1, surface 10 is preferably coated with a granulated particle substance 14 (illustrated for clarity in FIG. 1 as a sectional view on surface 10). The application of the granulated particle substance is known in the art and is commercially available. There are several preferred methods of application. One such process employed, is described, at least in part in the known art, comprises a die surface, which preferably will ultimately grip the targeted tubular, substantially uniformly covered by a paste composed or metallic matrix of at least one powdered metal, preferably nickel chromium with or without boron, mixed with an epoxy and imbedded with a layer of finely crushed particles, preferably tungsten carbide. The entire die, with the paste compound or metallic matrix, is then heated, preferably in a vacuum furnace, to cause the metallic matrix to bond to the die surface onto which it was spread. The granular particles may also be applied by sprinkling over the past compound or metallic matrix.

It should be appreciated, by those skilled in the art, that other methods of application may be used such as when surface 10 of the die 2 is preferably coated with a nickel chrome alloy, which is usually pooled on surface 10, and a granulated tungsten carbide which is sprayed into the pooled nickel chrome on the steel. This granulated particle surface coating 14 is a commercially available product, the application of which is best described in prior art. It should also be appreciated that although the commercial application of the granulated particles may call for a nickle chrome base, other metals may be used for the base. The pooled nickle, on surface 10, provides for a softer layer of material than the material of the die 2. Therefore, a superior bond is formed when applying a softer base material. Thus, it should be noted that other softer metals can be utilized as the base for the granular particles. Such metals may include, but are not limited to, copper, various copper alloys, various nickle alloys, stainless steels, and other metals. It should be noted that a multiple layer of bases can also be used. As an example which is not to be interpreted as being limiting, a stainless steel coating may be applied directly to the base metal of the die 2. Next, another material, such as the nickle chrome, or other softer metals such as, but are not limited to, copper, various copper alloys, various nickle alloys, and other metals may be applied on top of the stainless steel layer. Then, the granulated particles, which are preferably, but not limited to, granulated tungsten carbide, are sprayed, as described in prior art, onto the pooled softer material. It should be appreciated that all though the commercial granulated particle contains tungsten carbide, other combinations of hard particulated metals can be used. The granulated particles can also comprise hard non-metallic materials such as, but not limited, to conventional diamond tips such as are utilized in drilling bits and other technologies. It is envisioned that other particulated materials may be developed which may be applied as described herein or in a substantially similar method or with a substantially similar result. It should be appreciated that the granulated particle described herein should not be limited specifically to the embodiments presented as many hard materials could accomplish the same goal of producing a high friction gripping system while at the same time producing substantially no marks or very small marks in the tubulars being gripped. The granular particle coating 14 produces a high friction gripping surface on the face 10 of the die 2.

In use, when the jaws 4 flip the die 2 against the tubular member 3, the granulated particle gripping surface 14 is pressed against that tubular member 3. It should be understood that with a convex die 2, the actual contact area between the surface 10 and the tubular member 3 is relatively small as compared to a conventional concave shaped die. However, over the surface of the die face 10, that is in contact with the tubular member 3, the granular particles are microscopically penetrating the outermost surface of the tubular member 3.

It should be understood that because of the small size of the granular particles, it is only the outermost surface of the tubular 3 that is being penetrated; thus, this does not result in the deep or damaging mark produced by the prior art die “teeth” described herein above. Preferably, because this microscopic penetration is occurring over the entire contact surface, of the die 2 and the tubular 3, the gripping strength is substantial even without the deep penetration. Further, because the granular particles are applied to the die's gripping surface by a sprinkling process, as described in the known art, there is no uniform pattern in the positioning of the granular particles. Therefore, another disadvantage of uniform bite marks is eliminated.

The granular particles will preferably be distributed across a given size range. This results in the force of the initial bite being borne by the large particles, which make-up only a fraction of the total granular gripping surface. During this initial bite, these large particles have a much greater likelihood of penetrating the outer surface and properly gripping the tubular. This is distinguished from the prior art steel “tooth” gripping surfaces, which engage a tubular with all “teeth” simultaneously. It should be understood that the distribution of the initial bite force equally across all the steel “teeth” make it less likely that the “teeth” will be able to obtain a secure initial bite. Further, the lack of such a secure initial bite will result in slippage and significant damage to the tubular as described herein above. An embodiment of the granular particle coating 14 and the process used to apply it to the backing surface of the die is disclosed in the known art.

It should be understood that the granular particle coating 14 produces a substantially higher coefficient of friction between the tubular 3 and the die face 10. This higher coefficient of friction allows the present invention to firmly grasp the tubular member 3 under substantially higher torque loads than previous methods. It should be appreciated that the higher coefficient of friction is preferably further enhanced by the use of the braking apparatus as described herein above. As disclosed in the prior art it is believed that the superior gripping ability, of the granular particle coating, is at least partially a result of the heating process that the dies 2 undergo during application of the granular particle coating to the underlying steel face. The heating process causes the underlying metal face of the die insert to anneal, thus becoming softer. When the die insert is pressed against the harder tubular 3, the granular particles tend to become partially embedded in the underlying metal on the face of the die 2. Therefore, the sheer forces imparted to the granular particles when torque is applied to the tubular are resisted, not only by the braising alloy but also by the portion of the particle embedded in the die surface 10.

The Applicant has discovered that the substantially higher coefficient of friction between the tubular member 3 and the engaging die 2 is sufficient even for the small contact surface area of a convex shaped die. Therefore, when the predetermined amount of dies 2 are inserted in the tong 9, the total surface area between the several dies 2 and the tubular 3 is preferably sufficient to produce the high torques necessary to make-up or break-out the tubular members 3. It should be appreciated, by those skilled in the art, that conventional mechanical grip tongs utilize more gripping dies than do conventional power grip tongs. Thus, the additional contact points preferably provide the necessary contact surface area. Therefore, it should be appreciated that the use of the granular particle grip surface 14 on the convex shaped die 2, with the utilization of a braking apparatus, will now allow mechanical grip tongs 9 to be utilized in the make-up and break-out of corrosion resistant alloy tubulars, which require that the tubulars are not marked, scratched or gouged.

A distinct advantage of utilizing the convex dies 2 with the granular particle gripping surface 14 is that the same die 2 can be used for a variety of different tubular diameters. As discussed herein above, the known art teaches that concave dies or jaws whose surface matches the diameter of a tubular member can only be used with that particular diameter size of tubulars. Therefore, when using the convex shaped dies 2 and a larger tubular, such as when running casing or tubing, is required, the entire tong does not have to be disassembled to change out the dies 2.

Another embodiment of the present invention serves to further extend the use of a single sized die for a variety of tubular sizes through the use of a relatively easily attachable extension adaptor. As is illustrated in FIG. 1C, an adaptor 16 may be attached to jaw 4 between die 2 and the jaw 4. Preferably, the adaptor 16 may have one end configured so as to fit with jaw 4, at connection point 12a, in the same manner as the connection between die 2 and jaw 4. Further, the other end of the adaptor 16 may preferably be configured so as to connect to the die 2 at connection point 12 in the same manner as when the die 2 is connected directly to the jaw 4. It should be apparent, to those in the art, that the adaptor 16 can be configured so as to fit between the jaw 4 and the die 2 regardless of the configuration of the jaw 4 and the die 2, including, but not limited to convex, concave, flat, v-shaped, or other shapes of the die 2. It should be further apparent that the size of the adaptor can vary so as to allow the die 2 to extend further in a radial direction away from the jaw 4. It should also be understood that the connections 12, 12a can be a variety of connectors known in the art such as, but not limited to, pins, bolts, screws, rivets, welds and the like. Preferably, the connections 12, 12a are such that the assemblies can be readily detached or attached without using substantial rig time or setup time and therefore saving costs due to their utility and versatility. It should be appreciated, by those in the art, that the term rig time generally refers to operations conducted on a rig particularly during drilling or when running casing or tubing; the term setup time generally refers to other operations such as may be performed adjacent to a rig, in a pipe yard, in a pipe manufacturing or threading plant and the like. It should be understood that the use of these terms is not intended as a limitation in that they are used for convenience in the descriptions. Further, the dies, adaptors, and coatings described herein have the potential for a wide range of adaptability such as, but not limited to, most conventional and specialty tongs including various rig tongs, elevator gripping systems, make-up and break-out machines, other portable tongs, tongs used in threading lines and operations, tongs used in pipe yards, and similar gripping apparatuses.

In an embodiment, of the present apparatus, preferably one die will handle several consecutive sizes. This is best illustrated in FIG. 1B wherein die 2 is shown being utilized with several successive larger diameter tubulars, designated for clarity with the numerals 3-3f. It should be understood that FIG. 1B illustrates that the contact area between the die 2 and the tubular 3-3f would be substantially the same. Further, it should be appreciated that the convex die 2 may not be suitable for all tubulars 3-3f. However, with the adaptor 16 extensions (FIG. 1C) the dies 2 are preferably readily adapted to a larger variety of tubular diameters. It should be understood that in some circumstance there may be a need to adjust the length of the jaws 4, typically by replacing the jaws 4 or a component of thejaws. However, the exact diametrical size range of tubulars 3, which can be accommodated by a particular combination or size of jaws 4, dies 2, and/or adaptors 16 is preferably pre-determined prior to the tubular handling. Still further, it should be appreciated that the contact surface area can be enlarged by utilizing more dies 2 or dies 2 that are dimensioned such that they can contact a longer axial section of the tubular. It should be understood that with the convex die, the contact area is preferably smaller along the circumferential direction and larger along the axial direction of the tubular 3. It should even further be understood that the number of dies 2 required is a factor of the diameter of the tubular 3. Preferably larger tubular sizes would require more dies 2 in order to sufficiently contact enough of the tubular surface area to allow achievement of a required or desired torque. For example, but not limiting, the tubulars designated 3d-3f may require more dies 2 positioned around the circumference than the tubulars designated 3-3e. However, it should be appreciated, by those skilled in the art, that the changing of jaws or dies is expensive in terms of rig time or setup time. Therefore, if several sizes of tubulars 3 can be utilized with the same die 2, or with the same dies 2 and adaptor 16, there is a great savings in down rig time or setup time and therefore operational costs.

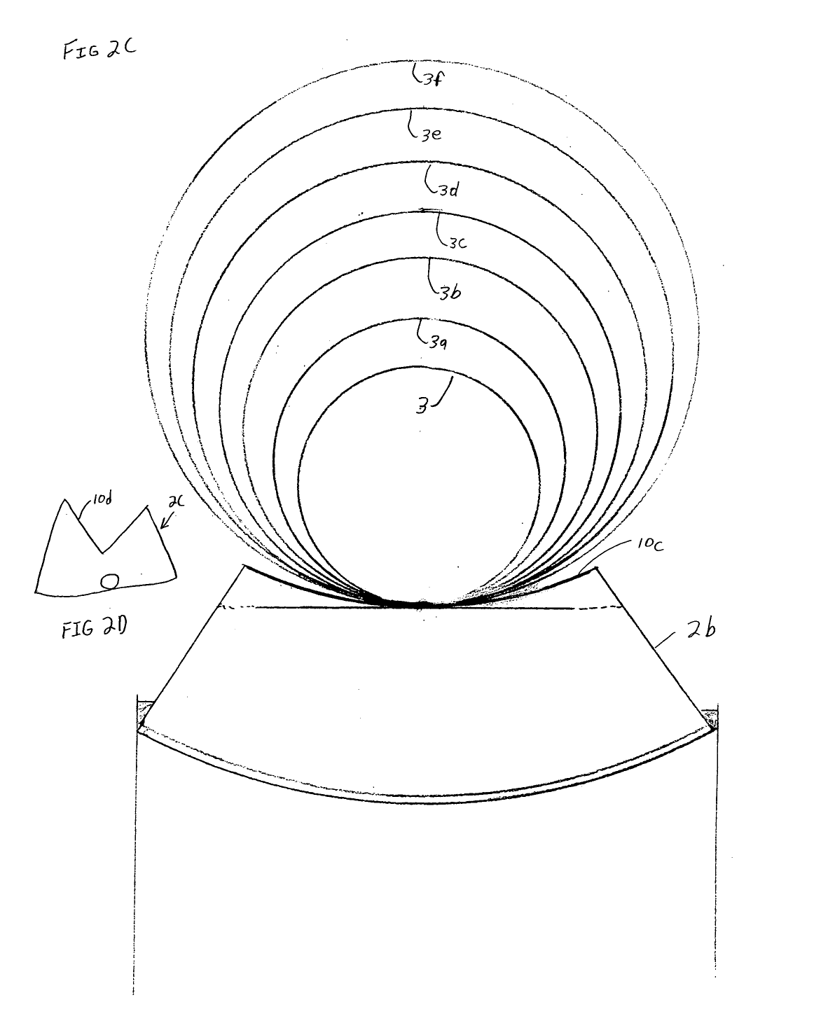

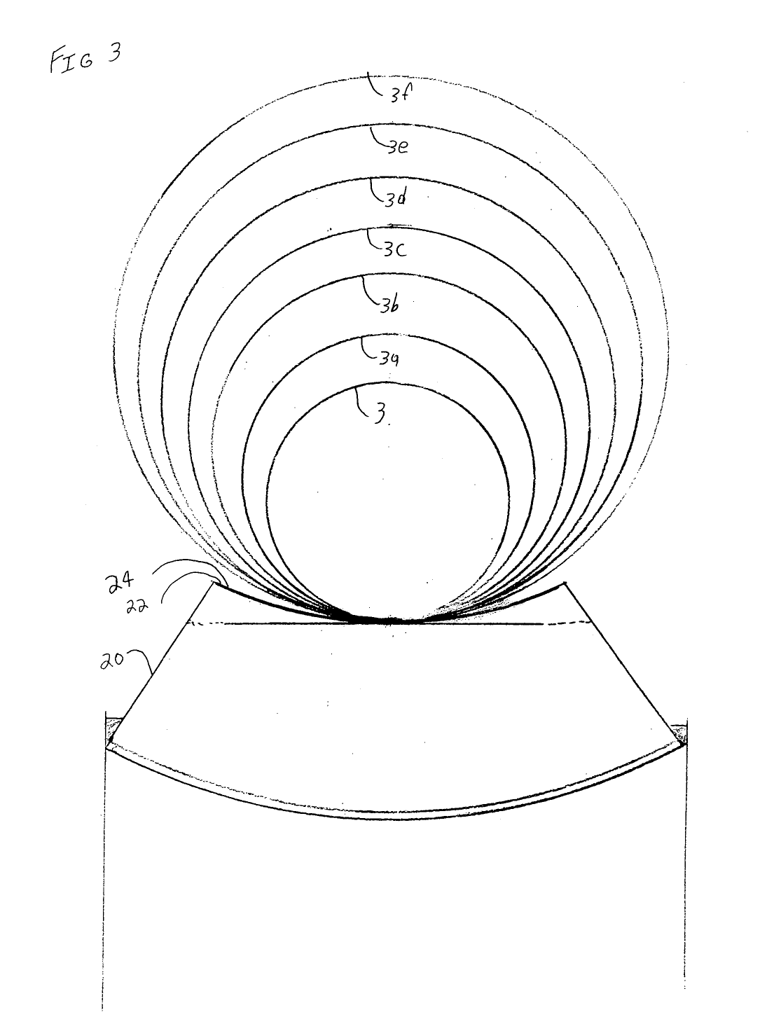

FIG. 2 illustrates another embodiment of the present invention. It should be appreciated that the detailed description of elements and operation, except as explicitly varied herein, are more fully described in the known art. In this embodiment, the dies 2a are concave shaped. The dies 2a, which preferably do not substantially match the diameter of the tubulars to be gripped, can be attached directly to jaws 4a. It should be appreciated that the concave shaped dies 2a can also be configured for use with an adaptor 16 which has been configured to fit between the die 2a and the jaw 4 as described herein above. In another embodiment, the dies 2a can be inserts in a die holder 2b which in turn is attached to the jaws 4a (FIG. 2B). In either of these embodiments, the dies 2a preferably have a substantially concave surface that contacts the tubular 3. It should be appreciated that in an embodiment, such as illustrated in FIG. 2B, the die holder 2b is preferably concave shaped and the dies 2a may have a contact surface that is concave, straight, or even convex. It should be further appreciated that the attachment of the dies 2a to the jaws 4a or as an insert (such as in die 2b) is done in a conventional manner such as described in more detail in the known art. The selected shape will preferably be selected to be suitable to contact a sufficient pre-determined amount of the tubular surface area to allow for the application of the required make-up or break-out torque without producing the undesirable marks, scratches or gouges in the tubular 3. It should further be appreciated that the shape of the die surface 10b is preferably concave shaped if the die 2a has a relatively long dimension in the circumferential direction.

Referring again to FIG. 2, an embodiment of this apparatus will preferably have dies 2a of which the faces, of the contact surface 10a, have no serrations, ridges, “teeth” or the like. FIG. 5 illustrates the face of a die 2a having no serrations, ridges, “teeth” or the like. These faces or contact surfaces 10a may be of a material that is softer than the material of the tubular 3 including, but not limited to, aluminum or a copper alloy. The soft metal contact surface 10a will allow the die 2a to be driven against the tubular member 3 and grip the tubular member 3 because the soft face deforms or flexes against the harder tubular member material. Therefore, the die 2a will preferably grip a tubular member 3 suitably to allow for the necessary torque for make-up and break up. Further, the softer material of the face, will prevent damaging marks, scratches, or gouges on the tubular member 3 being gripped due to the flexing of the softer material.

In another embodiment, which is generally illustrated in FIGS. 2 and 5, the dies 2a can be of a material that has substantially the same or greater hardness than the tubular 3. This embodiment still comprises a face or contact surface 10a that is substantially free of any serrations, ridges, “teeth” or the like. However, it is preferred that a silicon drywall mesh (not shown) or other suitable or acceptable material be inserted between the die 2a and the tubular member 3. Preferably, the silicon drywall mesh (not shown) or other suitable or acceptable material will create additional friction between the dies 2a and the tubular member 3 thus allowing the generation of the required torque for making-up or breaking-out tubular members 3 as well as prevent slippage between the dies 2a and the tubular member 3. It should be appreciated that an embodiment, such as illustrated in FIG. 2B, wherein the dies 2a are inserts, it is envisioned that the toothless or ridge free surface dies, as described herein above, may also utilize the silicon drywall mesh or other suitable or acceptable material inserted between the die 2a and the tubular member 3. It should further be appreciated that the silicon drywall mesh (not shown) or other suitable or acceptable material may also be used in conjunction with dies 2a, whether they are inserts as illustrated in FIG. 2B or are directly attached to the jaws 4a, that are of a softer material than the tubular material. Preferably, the primary purpose of the silicon drywall mesh (not shown) or other suitable or acceptable material is to generate additional friction to both avoid slippage which could mark or otherwise damage the tubular and allow the generation of more torque applied to the tubular. Therefore, the silicon drywall mesh (not shown) or other suitable or acceptable material may be used with either the softer dies or the dies which have a material hardness substantially the same as or greater than the tubular material to allow the generation of higher torques. It should be appreciated that slippage is more of a concern when the dies 2a are of a material which has substantially the same or greater hardness than the tubular. Preferably, dies 2a of a softer material will deform and otherwise absorb energy that may mark, scratch, or gouge the tubular 3. However, wherein the dies are of a material which has substantially the same or greater hardness than the tubular, the energy generated by the contact of the die surface with the tubular could be absorbed by either component and thus result in unwanted marks, scratches, or gouges on the tubular member. Preferably, the silicon drywall mesh will increase the friction to prevent slippage as well as protect the tubular member against scratches, other marks, or gouges. It should be further appreciated that when the material of dies 2a has a hardness which is substantially the same or greater than the hardness of the tubular, the die 2a may still be used without the silicon drywall mesh (not shown) or other suitable or acceptable material when lower torques are required. Preferably in such a case, the dies 2a will cause little or no marking on the tubular to be gripped. However, it should be understood that any mark which causes even a small amount of iron containing material to transfer from the die 2a to a tubular made from a corrosion resistant alloy may be unacceptable and that further any penetration of the tubular surface may cause stress points which are more susceptible to corrosion attack. Therefore, the use of a silicon drywall mesh (not shown) or other suitable or acceptable material would preferably be to minimize possible contact between the die 2a material and the tubular material. Preferably, to avoid the contamination of or surface damage to the corrosion resistant alloy tubular, the surface of the die 2a, which contacts the tubular, would be of a softer material such as, but not limited to, aluminum.

FIG. 2C illustrates an embodiment wherein the concave shaped dies 2b are preferably dimensioned such that the surface curvature is greater than the diameter of the tubular 3 to be gripped. In this embodiment, the same dies 2b could accommodate and suitably grip several diametrical sizes of tubular members 3, designated for clarity with element numbers 3-3f. As described herein above for the convex dies 2, the dies 2b of this embodiment would not require changing for each different diametrically sized tubular and would preferably generate operations cost savings. It should be noted that the utilization of adaptors 16, as described herein above, would preferably further accommodate the varying size range of tubulars being gripped. It should be appreciated that when the die 2b has a curvature greater than the diameter of the tubular, the tubular will tend to naturally find the center of the concave gripping surface 10c. It should further be appreciated that the contact surface area, in the instant embodiment, will typically be less than the contact surface area of a die wherein the contact surface substantially matches the curvature of the tubular. However, as is one of the novel attributes of the present invention, the concave dies described herein which have a surface curvature greater than the curvature of the tubular will still provide sufficient gripping pressure to allow for the generation of the necessary torque to make-up or break-out the tubulars.

It should be understood that, when a concave shaped die has a surface curvature that is smaller than the corresponding surface curvature of the tubular member being gripped, the contact is substantially limited to two (2) points of line contact. This is a result of the tubular member being incapable, because of the size limitations, of fitting inside the smaller diameter surface of such a concave die. It should be further understood that, when a concave shaped die has a surface curvature that is larger than the corresponding surface curvature of the tubular member being gripped, the contact is substantially a single point of line contact. Therefore, particularly in mechanical grip tongs, it is important to apply the required pre-load to the dies to assure that a suitable gripping force can be generated in conjunction with the contact surface area available. In an embodiment that utilizes a concave die which has a surface curvature larger than the corresponding diameter of the tubular being gripped, it should be understood that the number of contact points, between concave shaped die and the gripped tubulars, can be increased by providing axial cuts in the concave die. Such axial cuts create a analogous situation as described herein above in conjunction to concave dies that have a surface curvature smaller than the corresponding tubular diameter. Thus, the concave die, with the axial cuts will have more line contact points and thus more contact surface area.

In another embodiment, illustrated in FIG. 2D, shows that the die 2c has a substantially v-shape for the gripping surface 10d. It should be appreciated that the shape can be a more definite v-shape as well as have a more gradual bottom curvature thereby approaching a more u-shape. In either case, such a shaped die 2c would preferably function similar to a concave shaped die however, with most tubular sizes there would be two contact points, or contact lines, with the tubular to be gripped. Still further, the v-shaped die 2c can comprise the granular particle coating 14 described herein above, wherein at least one layer of a softer metal is pooled onto the surface 10d of the v-shaped die 2c and the granular particle coating is sprayed onto the pooled metal. The surface 10d can also be substantially free of any ridges, serrations, or “teeth”, or the like. In such a case, the braking apparatus, if utilized in a mechanical grip tong or the ram pressure, if utilized in a power grip type tong, would be adjusted to provide a preferably pre-determined force to ensure that the proper gripping friction is generated to prevent slippage and provide the necessary torque for making-up or breaking-out the tubulars. It should be noted that an additional frictional material such as, but not limited to, a silicone drywall mesh, may be preferably utilized, particularly with respect to the surface 10d being substantially free of any ridges, serrations, or “teeth”, or the like.

It should also be understood that due to the industry acceptable diametrical tolerances for tubulars, including couplings, it is rare for all tubulars and couplers, of a particular diameter to actually have the exact same diameter. Therefore, a die, that is cut for a certain diameter may not exactly match the curvature of a particular diameter tubular. Therefore, the surface curvature of a die will typically be a little smaller or a little larger than the corresponding diameter of the tubular being gripped. Therefore, the contact surface area may actually be reduced to substantially either one point of line contact (when the curvature is larger than the tubular diameter) or two points of line contact (when the curvature is less than the tubular diameter). Therefore, the pre-loading of the dies against the tubular being gripped becomes more important for achieving a no-mark make-up or break-out. Thus, the amount of braking, of the drag ring, becomes an integral part of the make-up and brake-out procedure. Thus, it should be appreciated that the slippage, of the dies, along the tubular member to be gripped may also be a factor of the fit between the die and the tubular being gripped. Therefore, an embodiment utilizing a conventional actuated hydraulic cylinder 30 (FIG. 4) or a braking apparatus (FIGS. 4A and 4B) can better provide the required drag ring 6 braking to achieve the necessary pre-load of the dies against the tubular member 3. It should be understood that when using the power grip tongs the frictional force or gripping force of the dies is preferably accomplished, at least in part, by the hydraulic force of the power grip tong rams which set the dies against the tubular being gripped.

It should be understood that the successful operation of the toothless or ridge-free face dies, whether they are of a material which is softer, a material of substantially the same hardness, or a material harder than the tubular material, or whether the dies match the diametrical curvature of the tubular 3, at least in part is a function of the pressure set by the tong 9a against the tubular member 3. This pressure is further a function of the pre-load of the dies 2a against the tubular 3, which in turn are a function of the drag placed against the drag ring 6 to produce the contact between the dies 2a and the tubular 3. The amount of drag on the drag ring 6 can be achieved in any manner such as, but not limited to, as described in the prior art, the utilization of stiffer pins, which typically initialize the drag, the use of a manual or remote controlled brake on the drag ring, the use of a ram to brake the drag ring, as described in conjunction with the conventional actuated hydraulic cylinder 30 and FIGS. 4, 4A, and 4B herein above, by conventional braking systems, or similar devices. It should be understood that the preferred method of braking is with a braking apparatus, as described herein above, which has been found to produce the best braking action; however, the use of other system should not be viewed as a limitation of the present invention. It should be appreciated that the amount of drag and therefore the amount of pressure, exerted by the dies 2a, should preferably have some pre-determined maximum value such that the tubulars are not deformed by excessive pressure.

FIG. 3 illustrates an embodiment of the present apparatus which comprises a concave die 20, which preferably has a contact surface 22 having a curvature greater than the diametrical curvature of the tubular 3. This embodiment further comprises a granular particle gripping surface 24 preferably deposited on the contact surface 22. The granular gripping surface 24 is preferably the same surface as applied to the convex dies 2 described herein above. It should be appreciated that since the die 20 has a curvature greater than the diametrical curvature of the tubular, the tubular will preferably tend to naturally find the center of the concave gripping surface 24. It should further be appreciated that the contact surface area, between surface 24 and the tubular 3 may be less than the contact surface area of a die wherein the contact surface substantially matches the curvature of the tubular. However, similar to the convex die 2, the granular gripping surface 24 preferably provides the required friction to grip the tubular 3 and to generate the torques required for the make-up or break-out of the tubular 3. Also, as described herein above, the contact surface area may be substantially double by machining a center cut in the concave die.

Still referring to FIG. 3, as is illustrated, the concave die 20 may be used for several different diameters of tubulars. In this embodiment, it is visualized that the concave die 24 can be used for at least seven (7) consecutive diameters of tubulars, designated for simplicity with the numbers 3-3f. It should be appreciated that for large diameter tubulars, the concave die 24 might not be able to accommodate as many differing diametrical sizes. Further, for larger diameter tubulars, the concave die 24 may need to contact a longer axial surface of the tubular 3 and that a greater number of the concave dies 24 may need to be arranged around the circumference of the tubular 3. It should also be understood that as the curvature of the gripping surface approaches one hundred and eighty (180) degrees the amount of contact surface approaches that of the convex die 2. However it should be appreciated, by those in the art, that the use of dies 20 provides cost savings as fewer die changes are required when moving to different diameter tubulars. It should further be appreciated that the use of adaptors, such as adaptors 16, as described herein above, between the dies 20 and the jaws may allow the dies 20 to accommodate a greater variety of sizes. Thus, the adaptors are changed to accommodate size changes as opposed to changing out the dies or the jaws. The concave dies 24 can be utilized in both mechanical grip tongs, or power grip tongs. It should be understood that the number of different diameter tubulars which can be accommodated by one size die is made for illustrative purposes only and not intended as a limitation.

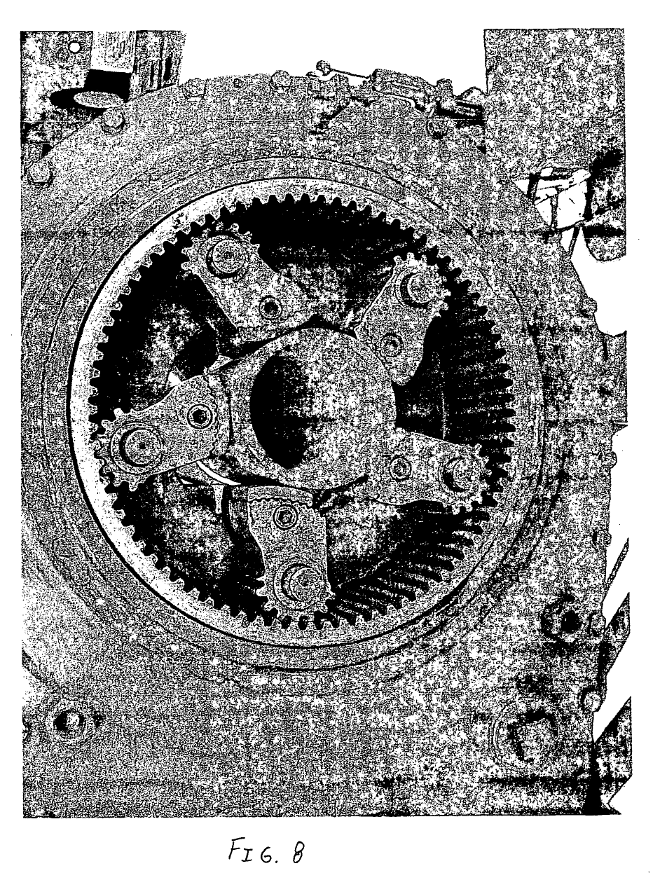

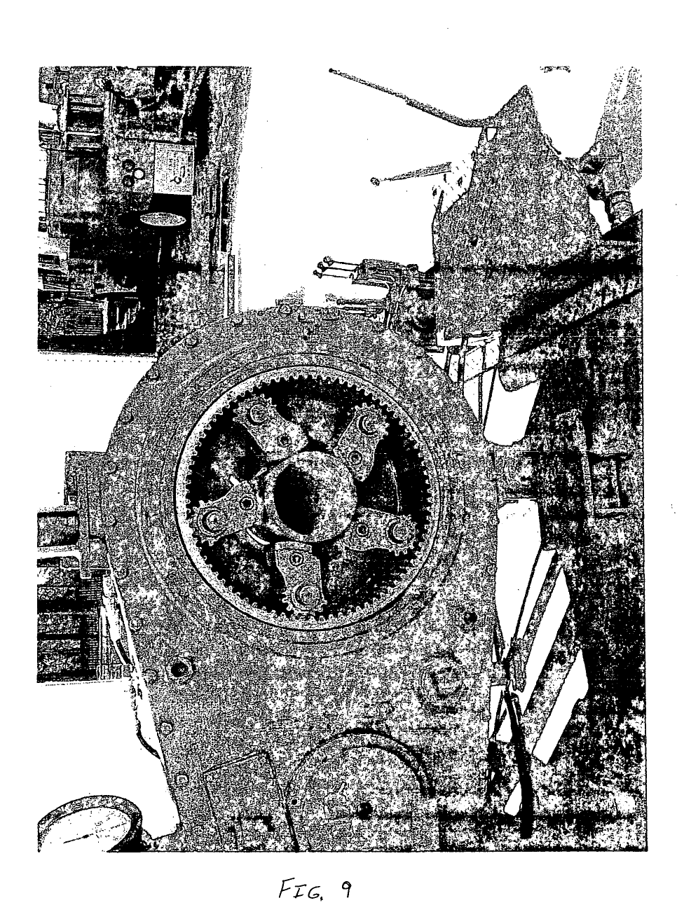

It is further envisioned that all the dies and die inserts described herein, particularly in FIGS. 1-9, can also comprise a non-metallic coating, such as, but not limited to, plastic, epoxy, combination of plastic and epoxy, rubber, or any similar composition coating on the surface which contacts or grips the tubular 3. Preferably, such a coating may be applied to dies whose surface is substantially free of any ridges, serrations, “teeth, or the like. However, such coatings can also be applied to other die surfaces including, but not limited to, the granular particle coated surfaces. The non-metallic coating, such as, but not limited to plastic, epoxy, combination of plastic and epoxy, rubber, or any similar composition is preferably a commercially available substance applied directly to the gripping surface of the dies or die inserts. The application of the non-metallic coating, such as, but not limited to plastic, epoxy, combination of plastic and epoxy, rubber, or any similar composition is as known in the art and may comprise heat cures, air cures, or used as applied. The distinct advantage of such coatings is to provide a non-penetration barrier between the die gripping surface and the surface of the tubular being gripped thus preventing scratching, gouging, or otherwise any marking of the tubular. A further advantage is to provide a frictional surface capable of generating the required toque for the make-up or break-out of the tubulars.

Operation

In utilizing the dies disclosed herein, the specific die employed becomes a factor of at least the type of conventional tong being utilized. A novel aspect, of the presently disclosed dies is that they may be used to replace other conventional dies typically utilized with conventional tongs. It should be appreciated that typically the dies will replace conventional dies with substantially the same shape (i.e. convex or concave). After the presently disclosed dies are attached to the jaws as described herein above or in the known art, the tongs are ready to grip the tubulars for make-up, break-out, or any other tubular gripping operation desired. It should be understood that the pre-load pressure required to initially grip the tubulars 3 is preferably pre-calculated based on the tubular diameter and material strength. Thus, the pre-load is preferably sufficient to grip the tubular to generate the suitable required torque and to prevent any tubular deformation, particularly with respect to the diameter. It should be further understood that the pre-load is preferably a function of the amount of braking applied to the drag ring 6 or the amount of force generated by the rams of a power grip tong.

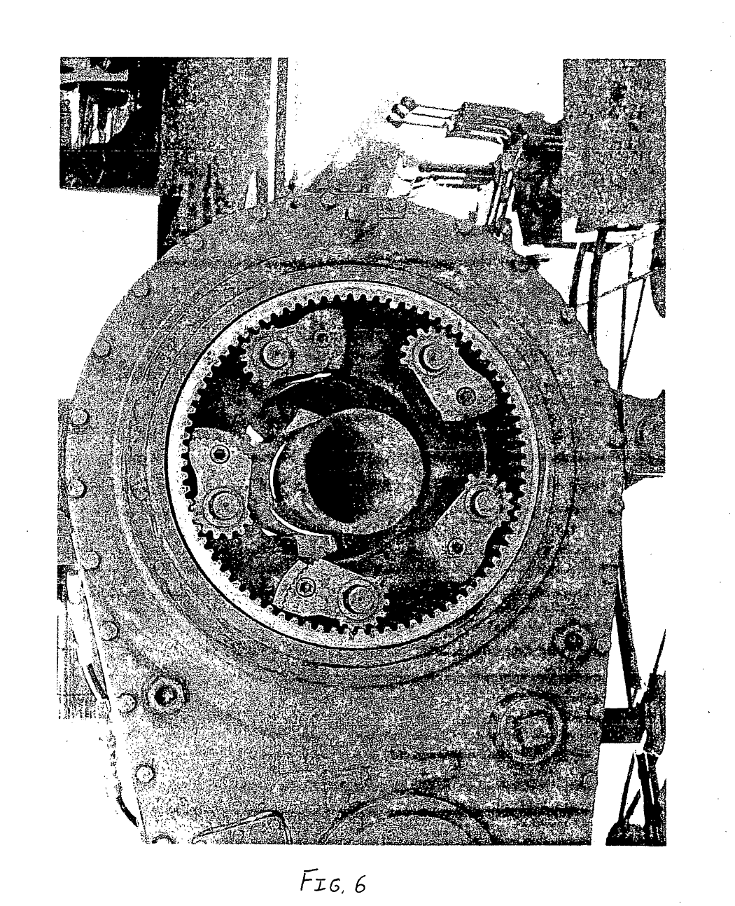

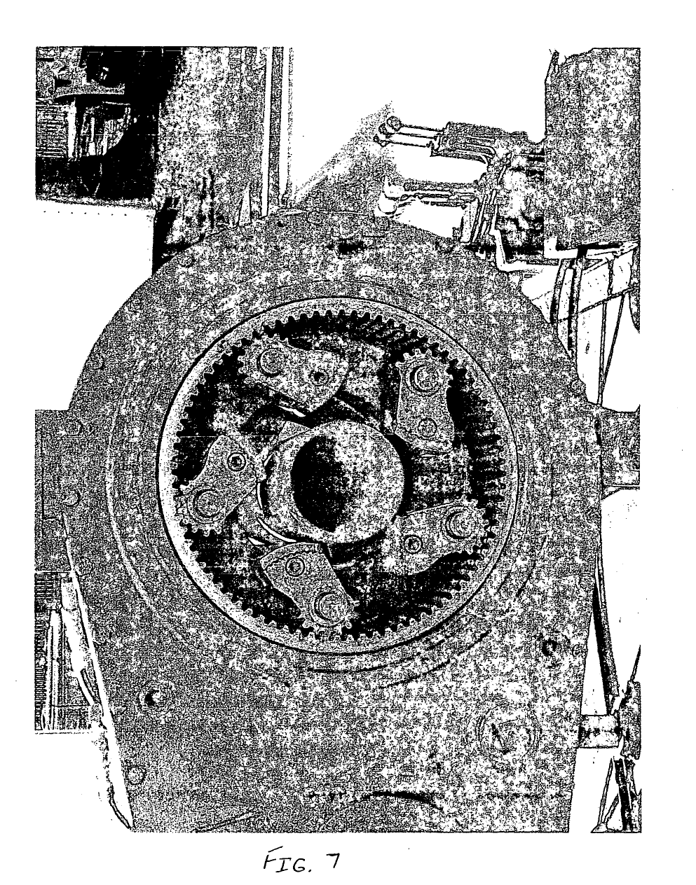

For clarity in understanding, FIGS. 6-9 illustrate a mechanical grip tong utilizing the particle coated dies 2 for gripping a tubular. This series of figures illustrates the steps as the dies 2 are moved to grip the tubular 3. The rotation of the dies, against the tubular 3 to be gripped, is due to the braking action against the drag ring 6 (which cannot be seen in these figures).

From the foregoing, it will be seen that the present invention is one well adapted to suitably grip tubulars, particularly for, but not limited to, the make-up and break-out of the tubular members. The present invention provides a compact, relatively simply constructed, mechanically rugged and highly useful dies for engaging and gripping tubulars as they are made-up or broken-out. It should be appreciated that certain embodiments of the present invention are not limited to specifically interact with oilfield tubulars, they can likewise be adapted to other uses where the gripping of tubulars of various sizes or positions is required or desired. It should be noted that these dies can be used with most conventional and specialty tongs including various rig tongs, elevator gripping systems, make-up and break-out machines, other portable tongs, tongs used in threading lines and operations, tongs used in pipe yards, and similar gripping apparatuses. It should be further appreciated that other advantages which are obvious and which are inherent to the present invention should not be limited by the examples presented in the foregoing descriptions. It will be understood that certain features and sub-combinations are of utility and may be employed without reference to other features and sub-combinations. This is contemplated by and is within the scope of the claims. Because many varying and different embodiments may be made within the scope of the inventive concept(s) herein taught, including but not limited to, all matter herein set forth or shown in the accompanying drawings and because many modifications may be made in the embodiment herein detailed in accordance with the descriptive requirements of the law, it is to be understood that the details herein are to be interpreted as illustrative and not in a limiting sense.

1. A convex shaped die for gripping a tubular comprising:
a back side configured for attachment to a jaw member, wherein said jaw member is attached to a gripping system for gripping tubulars;
a front side for application of a gripping surface to grip said tubular, wherein said front side is adapted to grip the tubular;
said front side further comprising at least one metallic overlay surface; and
said at least one metallic overlay surface further comprising a granular particle surface applied over said at least one metallic overlay, wherein said granular particle surface engages said tubular initiating improved gripping.

2. The die of claim 1, further comprising ajaw member, wherein said back side of said die is detachably affixed to said jaw member.

3. The die of claim 2, wherein said jaw member is a part of a gripping tong system.

4. The die in claim 1, further comprising a metallic material, wherein said at least one metallic overlay is of a material softer than said metallic material.

5. The granular particle coating of claim 1, further comprising a tungsten carbide material.

6. The die in claim 1, further comprising a non-metallic overlay, wherein said non-metallic overlay engages said tubular initiating improved gripping.

7. A gripping system for gripping tubulars comprising:
at least one tubular to be gripped;
a die comprising a metallic material, said die having a front side and a back side wherein said front side is of a substantially convex shape;
said front side of said substantially convex shaped die further comprises at least one metallic overlay;
said front side of said die further comprising a granulated particle surface applied on top of said at least one metallic overlay, wherein said granulated particle surface engages said tubular;
a jaw member wherein said back side of die is detachably affixed to said jaw member, and wherein said jaw member allows said die to engage said tubular;
saidj aw member being pivotally attached to a rotationally capable drag ring, wherein said rotationally capable drag ring controls a gripping force of said die against said tubular;
a substantially cylindrical apparatus, wherein said cylindrical apparatus is fixedly attached to said rotationally capable drag ring;
a band, having two ends, disposed about said substantially cylindrical apparatus;
said band further having an outside surface and an inside surface wherein a friction material is disposed about said inside surface; and
an apparatus for exerting a force on said band wherein said force causes said friction material to slidingly engage said substantially cylindrical apparatus to retard a rotation of said rotationally capable drag ring and substantially cylindrical apparatus, whereby said retarding of rotation increases the force of gripping by said die of said tubular.

8. The gripping system of claim 7, wherein said apparatus for exerting a force is a conventional actuated hydraulic cylinder.

9. The gripping system of claim 7, further comprising an adaptor, having a first end and a second end, wherein said first end is detachably affixed to said back of said die, and wherein said second end is detachably affixed to said jaw member.

10. The die in claim 7, further comprising a non-metallic overlay, wherein said non-metallic overlay engages said tubular initiating improved gripping.

11. A gripping system comprising:
a die member for gripping tubulars, wherein said die is substantially concave shaped;
said die member having a front surface and a back surface;
said front surface is shaped so that the radius of curvature of said concave surface does not match the outside diameter of the tubular being gripped; and
said front surface is substantially free of surface interruptions, wherein said surface comprises at least one metal.

12. The die of claim 11, wherein said front surface comprises a metal that is softer that said metal surface of the tubular being gripped.

13. The die of claim 11, wherein said front surface is of substantially the same or greater hardness than the hardness of the tubular being gripped.

14. The die of claim 11, wherein said front surface is of a substantially v-shape.

15. The die in claim 14, further comprising a non-metallic overlay, wherein said non-metallic overlay engages said tubular initiating improved gripping.

16. The die of claim 11, wherein said concave surface comprises at least one axial cut.

17. The die of claim 11, wherein said front surface has a radius of curvature substantially smaller than the tubular being gripped.

18. The die of claim 11, wherein said front surface has a radius of curvature substantially larger than the tubular being gripped.

19. The die in claim 11, further comprising a non-metallic overlay, wherein said non-metallic overlay engages said tubular initiating improved gripping.

20. A gripping system comprising:
a die having a front surface and a back surface wherein said front surface is substantially concave;
said front surface is shaped so that the radius of curvature of said concave surface does not match the outside diameter of a tubular being gripped;
said die member comprising a metallic material;
said front surface further comprises at least one metallic overlay; and
said front surface further comprises a granulated particle surface applied on top of said at least one metallic overlay, wherein said gripping system is a power grip tool.

21. The die of claim 20, wherein said front surface has a radius of curvature substantially smaller than the tubular being gripped.

22. The die of claim 20, wherein said front surface has a radius of curvature substantially larger than the tubular being gripped.

23. The gripping system of claim 20, wherein said gripping system is a mechanical grip tong.

24. The die in claim 20, further comprising a non-metallic overlay, wherein said non-metallic overlay engages said tubular initiating improved gripping.

25. A gripping system comprising:
a die having a front surface and a back surface wherein said front surface is substantially concave;
said front surface is shaped so that the radius of curvature of said concave surface does not match the outside diameter of a tubular being gripped;
said die member further comprising a metallic material; and
said front surface is substantially free of surface interruptions, wherein said gripping system is a mechanical grip tong.

26. The die of claim 25, wherein said front surface has a radius of curvature substantially smaller than the tubular being gripped.

27. The die of claim 25, wherein said front surface has a radius of curvature substantially larger than the tubular being gripped.

28. A gripping system comprising:
a tubular to be gripped by said system;
at least one die;
at least one jaw member;
an adaptor, wherein said adaptor extends radially said at least one jaw member, and wherein said adaptor fits between said at least one die and said at least one jaw member;
a drag ring, wherein said jaws are pivotally attached to said drag ring;
a brake drum fixedly attached to said drag ring; and
a band disposed about said brake drum wherein said band exerts a braking friction to said brake drum when activated.

29. The gripping surface of claim 28, wherein said die has a substantially concave surface.

30. The die in claim 29, further comprising a non-metallic overlay, wherein said non-metallic overlay engages said tubular initiating improved gripping.

31. The gripping system of claim 28, wherein die surface is substantially convex in shape.

32. The die in claim 31, further comprising a non-metallic overlay, wherein said non-metallic overlay engages said tubular initiating improved gripping.

33. The gripping system of claim 28, wherein said die is substantially v-shaped, and wherein said tubular to be gripped is gripped at more than one point of contact.

34. The die in claim 33, further comprising a non-metallic overlay, wherein said non-metallic overlay engages said tubular initiating improved gripping.

35. The gripping system of claim 28, wherein said concave shape of die has a radius of curvature substantially greater than said tubular to be gripped, and wherein said die has a gripping contact surface at one point.

36. The gripping system of claim 28, wherein said die has a radius of curvature substantially less than said radius of curvature of tubular to be gripped, and wherein said die surface has at least two points of gripping contact.

37. A method of gripping a tubular comprising the steps of:
providing at least one substantially convex die;
coating said at least one substantially convex die with at least one metal overlay and a granular particle surface;
attaching the die to a jaw member;
pivotally attaching said jaw member to a drag ring;
fixedly attaching a brake drum to said drag ring;
disposing a braking band about said brake drum, wherein said braking band applies a frictional force to said drum when activated;
gripping a tubular with said at least one substantially convex die;
activating said braking band to provide frictional force against drum; and
providing said braking action to generate sufficient predetermined torque to turn tubular.

38. The method of claim 37, wherein said die has a substantially concave shape, and wherein the radius of curvature of said substantially concave shape does not match an outside diameter of the tubular to be gripped.

39. The method of claim 38, further comprising the step of coating said die with a non-metallic overlay, wherein said non-metallic overlay engages said tubular initiating improved gripping.

40. The method of claim 38, further comprising the step of adding a frictional material to said gripping surface of said concave shaped die.

41. The method of claim 37, wherein said die has a substantially v-shape.

42. The method of claim 37, further comprising the step of attaching an adaptor, wherein said adaptor extends radially said at least one jaw member, and wherein said adaptor fits between said at least one die and said at least one jaw member.
